(19) United States
(12) Patent Application Publication
(10) Pub. No.: US 2007/0243812 A1
(43) Pub. Date: Oct. 18, 2007

(54) Device for ventilating a vehicle

(75) Inventors: Reinhold Burr, Heidenheim (DE); Alexander Foeldi, Munchen (DE)

Correspondence Address: FOLEY AND LARDNER LLP;SUITE 500, 3000 K STREET NW, WASHINGTON, DC, 20007, US

(73) Assignee: BEHR AMERICA, INC.

(21) Appl. No.: 11/389,505

(22) Filed: Mar. 27, 2006

(51) Int. Cl. B60H 1/34

(52) U.S. Cl. 454/155

(57) ABSTRACT

A device for ventilating a vehicle comprises a first air flap arranged in an air path and at least one second air flap that are adjustable by means of a rotatable shaft. A slotted link connects at least the second air flap to the shaft to provide for movement of the flap under positive control in response to rotation of the shaft. Rotation of the shaft initially produces a movement of the first flap and subsequently a movement of the second flap

### BACKGROUND OF THE INVENTION

The invention relates to a ventilation device, especially a device useful for ventilating a vehicle. The device includes a first air flap arranged in an air path, and at least one second air flap. A shaft is arranged for rotation to initially effect a movement of the first flap and subsequently also a movement of the second flap.

In ventilation systems for motor vehicles, it is known to arrange a plurality of air flaps in such a manner that, initially, a first flap and, subsequently, a second flap is opened. In this case, the opening may be drivable by a rotatable shaft. The flaps are generally biased in a closing direction by means of a spring, whereas mechanical opening means only act counter to the direction of the spring. This requires a large number of components and also entails the risk of the air flaps remaining stuck in an open position due to adhesion or jamming. When improving existing devices, consideration has to be taken in particular of the increasing demands in motor vehicle construction for reliability, low production costs, durable and nevertheless favorable materials and small construction space.

### SUMMARY OF THE INVENTION

It is therefore one object of the present invention to provide a device for ventilating a vehicle, in which particularly few components are required. It is a further object of the invention to provide a device for ventilating a vehicle, in which air flaps can no longer remain stuck in a position. It is a further object of the invention, in turn, to provide a device for ventilating a vehicle, in which the air flaps are guided in a defined manner over the entire range of rotation.

In accomplishing these objects, there has been provided in accordance with one aspect of the present invention a device suitable for ventilating a vehicle, comprising: a first air flap adapted to be arranged in a first air path, at least one second air flap adapted to be arranged in a second air path, a rotatable shaft for adjusting the position of the first and the second air flaps, and a slotted link mechanism connecting at least the second air flap to the shaft in a manner to adjust the second air flap under positive control, wherein the slotted link mechanism causes a movement of the second flap at a time different from movement of the first flap in response to rotation of the shaft.

In accordance with another aspect of the invention, there has been provided a method for operating a device for ventilating a vehicle, comprising: moving a first air flap adapted to be arranged in a first air path, moving at least one second air flap adapted to be arranged in a second air path, wherein said moving comprises rotating a rotatable shaft for adjusting the position of the first and the second air flaps, and driving at least the second air flap, by the rotation of the shaft, in a manner to adjust the second air flap under positive control and to cause a movement of the second flap at a time different from movement of the first flap in response to rotation of the shaft.

Further objects, features and advantages of the present invention will become apparent from the detailed description of preferred embodiments that follows, when considered together with the accompanying figures of drawing.

### BRIEF DESCRIPTION OF THE DRAWINGS

In the drawings:

FIG. 1 is a diagrammatic plan view showing a first exemplary embodiment of a device according to the invention;

FIG. 2 is a lateral plan view showing a flap of the device from FIG. 1, where the flap is provided with a slotted link;

FIG. 3 is a diagrammatic plan view showing a second exemplary embodiment of a device according to the invention;

FIG. 4 is a three-dimensional view showing the first exemplary embodiment in a first flap position;

FIG. 5 is a three-dimensional view showing the first exemplary embodiment in a second flap position;

FIG. 6 is a three-dimensional view showing the first exemplary embodiment in a third flap position; and

FIG. 7 is a diagrammatic sectional view showing a front region of the interior of a motor vehicle.

### DETAILED DESCRIPTION OF THE PREFERRED EMBODIMENTS

A preferred device according to the invention for ventilating a vehicle comprises a first air flap arranged in an air path, and at least one second air flap. A rotatable shaft is provided, and the first and the second air flaps are adjustable by means of the shaft. A slotted link connects at least the second air flap to the shaft under positive control, and rotation of the shaft initially effects movement of the first flap and subsequently a movement of the second flap. The positively controlled connection by means of the slotted link enables the second air flap to be driven both in an opening and in a closing direction, so that, firstly, additional closing mechanisms, such as, for example, return springs, can be omitted and, secondly, a force limited only by the material breaking points is exerted on the air flap both during the initiation of a closing movement and during the initiation of an opening movement.

In one preferred embodiment, the first flap is connected fixedly to the shaft. This permits a delayed actuation of one of the flaps in a particularly simple manner, since only the second flap is driven via a slotted link.

Furthermore, a rotation of the shaft that drives the first flap preferably takes place over an angle of rotation range of at least about 20 degrees, in particular at least about 30 degrees, before initiating a movement of the second flap from an end position from which it starts. This permits a particularly great separation of the movement of the first flap from a movement of the second flap.

The slotted link is preferably designed at least in some sections as a slot-shaped guide track. In this case, the slotted link may preferably be connected fixedly to the second flap. As another alternative, the slotted link may also be designed as a slot in a slotted disk, which is preferably fixedly connected to the shaft driving the second flap via a pin arranged on the second flap.

In the interests of a simple and stable design of a device according to the invention, the shaft is preferably designed with an eccentric formation, particularly preferably a bent portion, for connection to at least one of the two flaps, i.e., either the first flap or the second flap. Such a formation or bent portion can transmit large forces and can be produced in a simple manner. Particularly advantageously, at least one of the two flaps, the first flap or second flap, extends through the region of the eccentric formation in at least one position. This optimally uses the available construction space and provides a particularly large pivoting angle for the flap that extends through the space.

Preferably, at least a third flap can be connected to the shaft. In this case, the third flap can be moveable either simultaneously with one of the two other flaps, or the third flap can be movable in a delayed or accelerated manner, so that, in particular, all three flaps can be actuated successively by a single shaft. In particular, for this purpose a slotted link of the third flap can be shaped differently from the slotted link of the second flap.

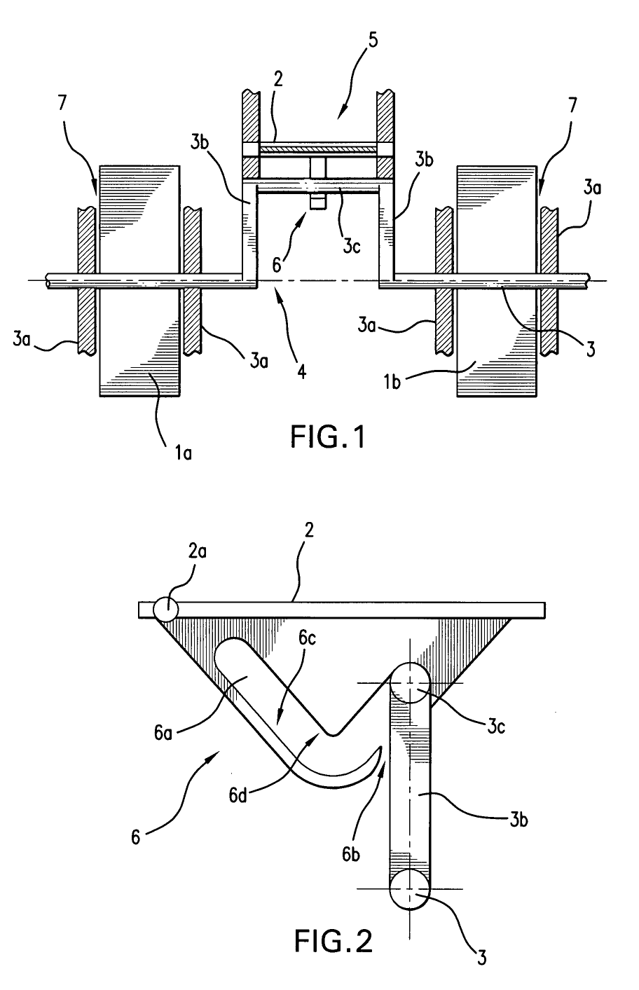

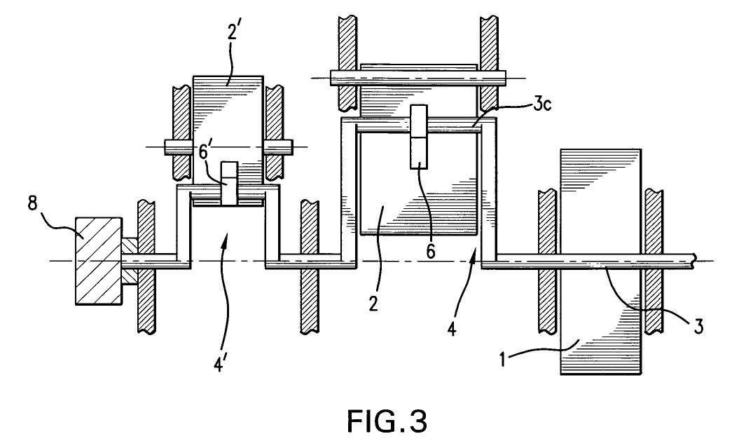

Turning now to the drawings, the device according to FIG. 1 comprises a number of air paths 5, 7 or an air path divided into a plurality of segments, where the air paths 5, 7 are closeable by a plurality of air flaps 1a, 1b, 2. For this purpose, a rotatable shaft 3 is provided which is mounted rotatably in bearings 3a which are provided in walls of the air paths 5, 7. The shaft 3 can be drivably rotated via a drive 8 (see FIG. 3).

Two flaps 1a, 1b of a first type of flap are in each case connected rigidly to the rotatable shaft 3, with the rotatable shaft 3 running through a common axis of rotation of the two flaps 1a, 1b. In the illustrated closed position of the two flaps 1a, 1b of the first type, the air paths 7, whose direction of flow runs perpendicularly to the plane of the drawing, are closed.

Remaining between the two flaps 1a, 1b is an intermediate space in which a further air path 5 is arranged. This air path runs in the plane of drawing sheet and therefore has a different direction than the first air path 7. In this intermediate region, the shaft 3 has a bent portion 4 which comprises two segments 3a, 3b running perpendicularly to the axis of rotation and a segment 3c running parallel to the axis of rotation. This segment 3c can be selectively shaped in accordance with the requirements. An air flap 2 of a second type is arranged in this region. In the closed position illustrated, the air flap 2 is oriented perpendicularly to the two other air flaps 1a, 1b. The second flap 2 is mounted rotatably via pins 2a on the air path 5 in which it is located. As the sectional view according to FIG. 2 shows, the second flap 2 comprises a slotted link 6 which is designed as a slot-shaped guide track and is preferably formed integrally with the flap 2 as a plastic injection-molded part. The guide track 6a of the slotted link 6 has an open section 6b via which the parallel limb 3c of the shaft 3 can be inserted into the guide track 6a. In the closed state according to FIG. 2, the limb 3c presses against a first side 60 of the guide track in order to press on the flap in the closed position in a force-actuated manner.

The invention operates as follows:

Starting from the closed flap position according to FIG. 1 and FIG. 2, a rotational movement is introduced into the shaft 3 by means of a drive unit, e.g., counter-clockwise in the view according to FIG. 2. The fixed connection of the two flaps 1a, 1b to the shaft 3 causes these two flaps of the first type to be immediately rotated and to open up an at least partial opening of the ventilation duct 7 assigned to the first flaps 1a, 1b. As a function of the shape of the guide track 6a, the second flap 2 is initially not moved until the shaft 3 has undergone a pivoting through an angle, which is preferably approximately 30 degrees from its initial position. From approximately this position, the limb 3c engages on the opposite side 6c of the guide track 6a, so that, upon further rotation of the shaft 3, the flap 2 is pulled under positive control into an opening position. As can be seen from FIG. 2, there is a form-fitting connection between limb 3c and guide track 6a in every operational position of the shaft 3, with the result that the flap 2 is driven in a positively controlled manner by the shaft 3.

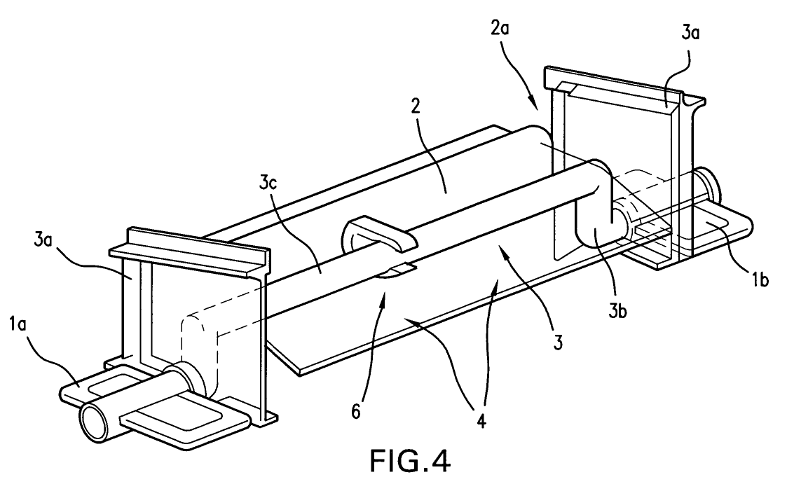

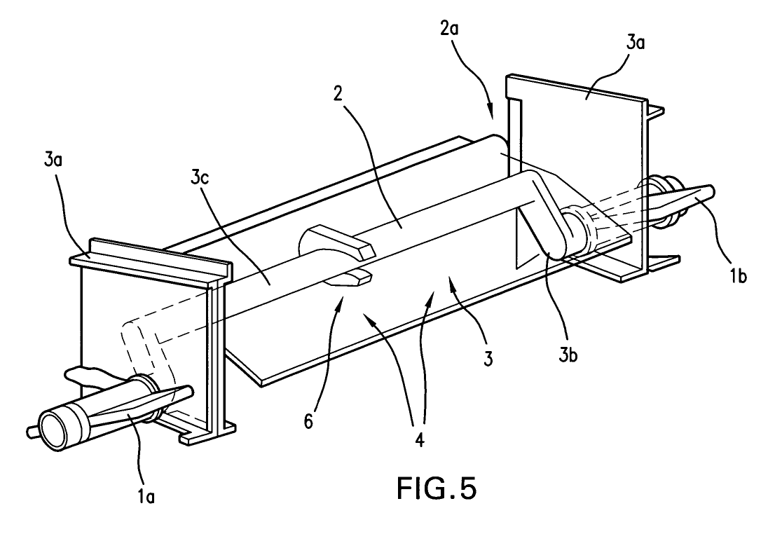

The illustrations according to FIG. 4 to FIG. 6 clarify the actuation sequence of the individual flaps during rotation of the shaft 3. In a first end position of the shaft 3 according to FIG. 4, the flaps 1a, 1b and 2 are in a respective end position. In this case, the flap of the second type 2 reaches through the region of the bent portion 4 of the shaft 3, as a result of which the construction space is optimally used. When the shaft 3 is rotated into the position according to FIG. 5, initially only those flaps of the first type 1a, 1b which are connected fixedly to the shaft 3 pivot, with the position of the flap of the second type 2 remaining essentially unchanged. This is achieved by a suitable shaping of the slotted link 6 which is fitted on the flap 2 and interacts with the bent region 3c of the shaft 3. After further rotation of the shaft 3 beyond a defined angular position, the flap of the second type 2 is essentially also pivoted, i.e., in the direction of rotation opposed to the flaps of the first type 1a, 1b.

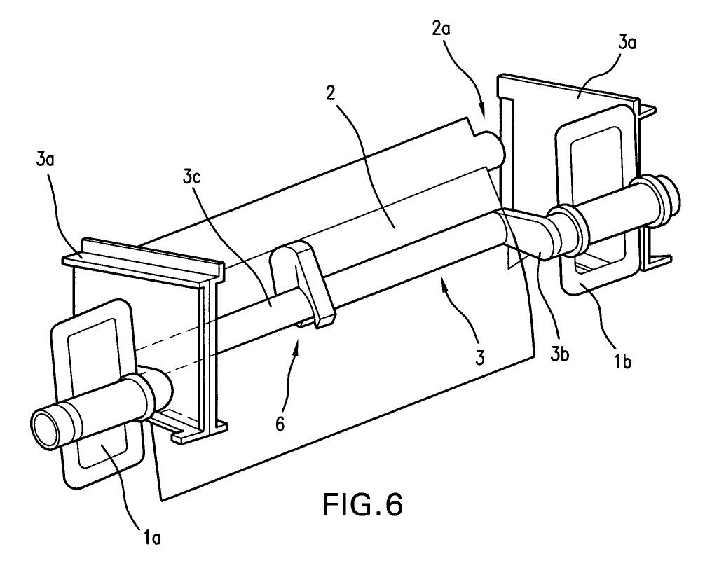

FIG. 6 shows an opposite end position, in relation to FIG. 4, of the shaft 3 and the flaps 1a, 1b, 2. It can be seen that, despite its initially delayed pivoting, the flap of the second type 2 has finally been pivoted through approximately the same overall angle as the flaps of the first type 1a, 1b, i.e., approximately 90 degrees.

A second preferred exemplary embodiment according to FIG. 3 differs from the first exemplary embodiment by the fact that only a single flap 1 of the first type is provided, and both a second flap 2 and a third flap 2′ of the second type are provided. The third flap 2′ is driven by a second bent portion 4′ of the shaft 3 and has a corresponding slotted link 6′. Depending on the shaping of the slotted link 6, 6′, it can therefore be provided that the third flap 2′ opens or closes in a delayed manner, both with respect to the first flap 1 and with respect to the second flap 2.

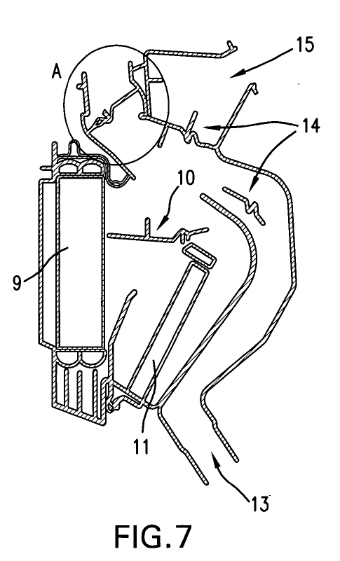

FIG. 7 shows diagrammatically a section through the dashboard region of a motor vehicle, in which a large part of the ventilation system for the interior is also arranged. The ventilation system comprises, inter alia, an evaporator 9, a mixing flap 10, a heater 11, a footwell duct 13, further flaps 14 and a ventilation opening 15. The device according to the first exemplary embodiment of the invention is arranged in a region A. In this case, the flaps of the first type 1a, 1b are used for side window ventilation and the large, central flap of the second type 2 is used for ventilation of the windshield.

The foregoing description of preferred embodiments of the invention has been presented for purposes of illustration and description only. It is not intended to be exhaustive or to limit the invention to the precise form disclosed, and modifications and variations are possible and/or would be apparent in light of the above teachings or may be acquired from practice of the invention. The embodiments were chosen and described in order to explain the principles of the invention and its practical application to enable one skilled in the art to utilize the invention in various embodiments and with various modifications as are suited to the particular use contemplated. It is intended that the scope of the invention be defined by the claims appended hereto and that the claims encompass all embodiments of the invention, including the disclosed embodiments and their equivalents.

1. A device suitable for ventilating a vehicle, comprising:
a first air flap adapted to be arranged in a first air path,
at least one second air flap adapted to be arranged in a second air path,
a single rotatable shaft for adjusting the position of both the first and the second air flaps, and
a slotted link mechanism connecting at least the second air flap to the single rotatable shaft in a manner to adjust the second air flap under positive control, wherein the slotted link mechanism causes a movement of the second flap at a time different from movement of the first flap in response to rotation of the single rotatable shaft.

2. A device according to claim 1, wherein the movement of the second flap takes place subsequently to movement of the first flap, in response to rotation of the single rotatable shaft.

3. A device according to claim 1, wherein the first flap is fixedly connected to the single rotatable shaft.

4. A device according to claim 2, wherein a rotation of the single rotatable shaft that drives the first flap takes place over an angle of rotation range of at least about 20 degrees before a movement of the second flap is initiated.

5. A device according to claim 4, wherein the angle of rotation of the first flap is at least about 30 degrees.

6. A device according to claim 3, wherein a rotation of the shaft that drives the first flap takes place over an angle of rotation range of at least about 20 degrees before a movement of the second flap is initiated.

7. A device according to claim 6, wherein the angle of rotation of the first flap is at least about 30 degrees.

8. A device according to claim 1, wherein the slotted link comprises at least in some sections a slot-shaped guide track.

9. A device according to claim 1, wherein the single rotatable shaft has an eccentric shape including a bent portion for connection to at least one of the first flap and said second flap.

10. A device according to claim 9, wherein at least one of the first flap and said second flap extends through the region of the eccentric shape in at least one position of the flap.

11. A device according to claim 1, further comprising at least one third flap arranged to be moved in response to rotation of the single rotatable shaft.

12. A device according to claim 11, wherein the at least one third flap is fixedly connected to the single rotatable shaft.

13. A device according to claim 11, wherein the at least one third flap is connected to the single rotatable shaft via a slotted link mechanism in a manner to adjust the third air flap under positive control, wherein the slotted link mechanism causes a movement of the third flap at a time different from movement of at least one of the first flap and the second flap in response to rotation of the single rotatable shaft.

14. A method for operating a device for ventilating a vehicle, comprising:
moving a first air flap adapted to be arranged in a first air path,
moving at least one second air flap adapted to be arranged in a second air path, wherein said moving comprises rotating a single rotatable shaft for adjusting the position of the first and the second air flaps, and driving at least the second air flap, by said rotation of the single rotatable shaft, in a manner to adjust the second air flap under positive control and to cause a movement of the second flap at a time different from movement of the first flap in response to rotation of the single rotatable shaft.

15. A method according to claim 14, wherein at least said second flap is connected to the single rotatable shaft by a slotted link mechanism.

16. A method according to claim 14, wherein the movement of the second flap takes place subsequently to movement of the first flap, in response to rotation of the single rotatable shaft.

17. A device according to claim 1, wherein the slotted link is fixedly connected to the second flap.

18. A device according to claim 1, wherein the single rotatable shaft comprises a first segment and a second segment, wherein the first segment and the segment are offset with respect to one another, and wherein an axis of rotation of the first segment and an axis of rotation of the second segment are parallel.

19. A device according to claim 18, wherein the single rotatable shaft comprises a third segment interposed between and connecting the first segment and the second segment and wherein the third segment is arranged perpendicularly with respect to the axes of rotation of the first segment and the second segment.

20. A ventilating system for a motor vehicle comprising a device according to claim 1.

21. A motor vehicle comprising a ventilating system according to claim 20.
